(19) United States
(12) Patent Application Publication
(10) Pub. No.: US 2018/0291655 A1
(43) Pub. Date: Oct. 11, 2018

(54) VEHICULAR DOOR LATCH DEVICE AND ATTACHMENT APPARATUS FOR VEHICULAR DOOR LATCH DEVICE

(71) Applicant: MITSUI KINZOKU ACT CORPORATION, Yokohama-shi (JP)

(72) Inventors: Shuntaro KIMURA, Yokohama-shi (JP); Hiroki HATTORI, Yokohama-shi (JP); Janani VISWANATHAN, Novi, MI (US)

(21) Appl. No.: 15/939,858

(22) Filed: Mar. 29, 2018

(30) Foreign Application Priority Data
Apr. 5, 2017 (JP) 2017-075394

(51) Int. Cl. E05B 79/04; B60J 5/04

(52) U.S. Cl. CPC E05B 79/04; B60J 5/0416; B60J 5/0413

(57) ABSTRACT

A vehicular door latch device includes at least one attachment tool that is locked to a module base, which is fixed to an inside door panel of a door, and a door latch that is locked to the module base via the at least one attachment tool by fixation by being fitted of the at least one attachment tool to the locking member. The vehicular door latch device includes a housing that accommodates a movable element. In the housing, at least one locking member to which the at least one attachment tool is fixed by being fitted is integrally formed.

### INCORPORATION BY REFERENCE

The disclosure of Japanese Patent Application No. 2017-075394 filed on Apr. 5, 2017 is incorporated herein by reference.

### BACKGROUND OF THE INVENTION

### Field of the Invention

The present disclosure relates to a vehicular door latch device and an attachment apparatus for a vehicular door latch optimal for a door in which door function components are modularized.

### Description of the Related Art

A door described in the U.S. Pat. No. 5,902,004 is provided with door function components including an outside door panel, an inside door panel, a module base (a “mounting plate” in U.S. Pat. No. 5,902,004) which is fixed to the inside door panel, and a door latch which is attached in advance to the module base. In the door, the module base having the door function components attached thereto is fixed to the inside door panel such that the door function components are arranged at predetermined positions in the door. Accordingly, the attachment performance is improved.

However, the door described in the U.S. Pat. No. 5,902,004 uses, as means for attaching the door latch to the module base, a method of fixing a cover plate (a “latch mount” in U.S. Pat. No. 5,902,004) of the door latch to the module base with a bolt. This causes a problem in which the outer shape of the door latch is large, and in which attachment of the door latch to the module base is poor.

In view of the problem of the conventional technology, an object of the present disclosure is to provide a vehicular door latch device and an attachment apparatus for a vehicular door latch, which enable downsizing of the door latch and efficient attachment of the door latch to a module base.

### SUMMARY OF THE INVENTION

A first aspect of the present disclosure includes a housing that accommodates a movable element. In the housing, at least one locking member to which at least one attachment tool that is locked to a module base is fixed by being fitted, is integrally formed. Accordingly, the housing can be downsized so that a vehicular door latch device can be downsized.

It is preferable that the at least one attachment tool includes a module base side to-be-locked member that is locked to the module base, and a door latch side to-be-locked member that is fixed by being fitted to the locking member. Accordingly, the attachment tool can be easily attached to the housing and the module base.

It is more preferable that the at least one locking member be a set of locking members, and each of the set of locking members be provided at both of the upper and lower portions of the housing. Accordingly, the door latch can be stably and reliably attached to the module base.

It is still more preferable that the at least one attachment tool be a set of attachment tools, and each of the set of attachment tools be provided at both of the upper and lower portions of the module base. Accordingly, the door latch can be stably and reliably attached to the module base.

It is still more preferable that the shape of each of the set of attachment tools be vertically symmetrical. Accordingly, the door latch can be reliably attached to the module base with a simple configuration.

A second aspect of the present disclosure includes an attachment tool that is locked to a module base which is fixed to an inside door panel of a door, and a vehicular door latch device which is locked to the module base via the attachment tool by the attachment tool being fixed by being fitted to the at least one locking member. Accordingly, the door latch can be efficiently attached to the module base via the attachment tool.

According to the present disclosure, a door latch can be efficiently attached to a module base with use of an attachment tool, and further, the door latch can be downsized.

### BRIEF DESCRIPTION OF THE DRAWINGS

FIG. 1A is an exploded perspective view for explanation of a door assembly.

FIG. 1B is a completion diagram of the door assembly.

FIG. 2 is a perspective view of a door latch according to the present disclosure, viewed from the diagonally front side.

FIG. 3 is a rear side view of the door latch.

FIG. 4A is a perspective view of an upper main portion in a state before attaching the door latch to a module base.

FIG. 4B is an enlarged perspective view of the upper main portion in a state in which the door latch is attached to the module base.

FIG. 5A is a perspective view of a lower main portion in a state before attaching the door latch to the module base.

FIG. 5B is an enlarged perspective view of the lower main portion in a state in which the door latch is attached to the module base.

FIG. 6 is a front view of a main portion in a state in which the door latch is attached to the module base.

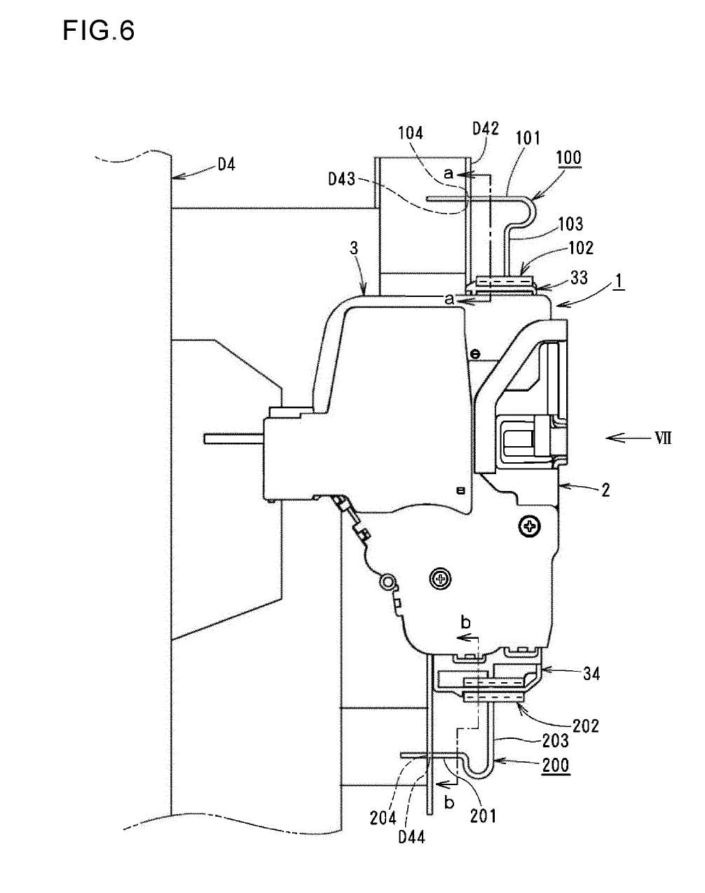

FIG. 7 is a view on an arrow VII in FIG. 6;

FIG. 8A is an enlarged cross-sectional view taken along line a-a in FIG. 6;

FIG. 8B is an enlarged cross-sectional view taken along line b-b in FIG. 6;

FIG. 9A is an enlarged cross-sectional view taken along line c-c in FIGS. 7; and

FIG. 9B is an enlarged cross-sectional view taken along line d-d in FIG. 7.

### DETAILED DESCRIPTION OF THE PREFERRED EMBODIMENTS

Hereinafter, one embodiment of the present disclosure is described with reference to the drawings.

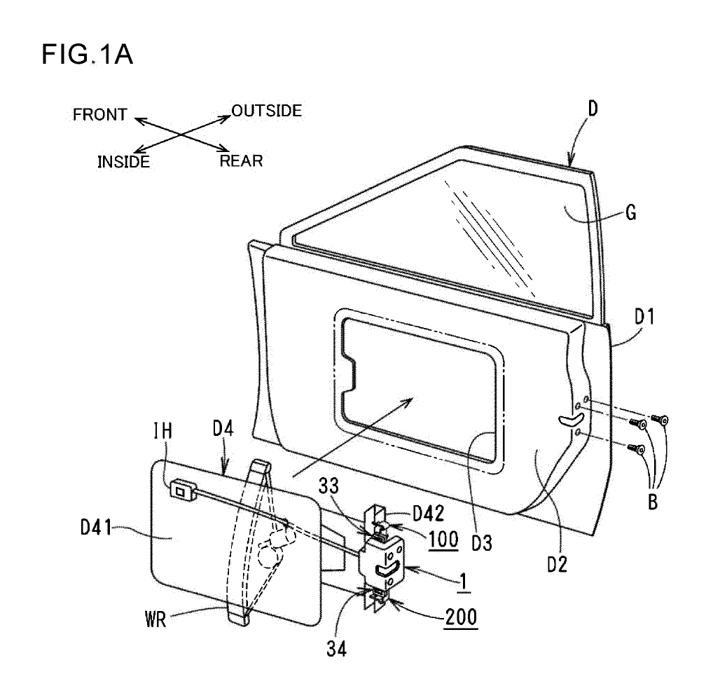

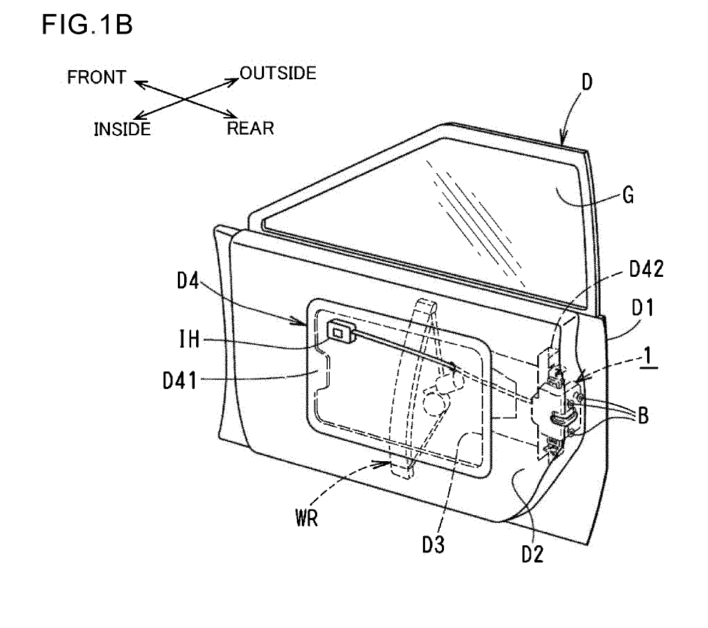

As illustrated in FIGS. 1A and 1B, door D is provided with door function components including outside door panel D1 forming a vehicle outer surface, inside door panel D2 forming a vehicle inner surface, module base D4 which is fixed to inside door panel D2, and door latch 1 which is attached to module base D4. Door D according to the present embodiment is a vehicular front door the front end of which is supported on a vehicular side surface so as to be openable and closable about a vertical axis. However, door D is not limited to a vehicular front door, and may be a vehicular rear door or a vehicular back door.

On outside door panel D1, an outside handle (not illustrated) which is operated when door D is opened from the outside of the vehicle and a key cylinder (not illustrated) which is operated when door locking/unlocking operation is performed.

Opening D3 for attachment of the door function components to door D is provided in inside door panel D2. Opening D3 is closed by fixation of module base D4 to inside door panel D2.

As illustrated in FIG. 1A, door latch 1, inside handle IH, window regulator WR, which are door function components, and other door function components are attached in advance to respective predetermined positions on module base D4. As illustrated in FIG. 1B, module base D4 having the door function components attached thereto is fixed to inside door panel D2 with a plurality of bolts (not illustrated) so as to close opening D3. Accordingly, the door function components attached to module base D4 can be arranged at respective predetermined positions in door D. However, window regulator WR is connected to window glass G by using a work hole (not illustrated) provided in module base D4, after module base D4 is fixed to inside door panel D2. After module base D4 is fixed to inside door panel D2, door latch 1 is fixed to the rear inner surface of inside door panel D2 with a plurality of bolts B. In the present embodiment, a configuration including at least door latch 1, upper locking member 33 (described later), and lower locking member 34 (described later) is referred to as a vehicular door latch device. In the present embodiment, a configuration including at least the vehicular door latch device, upper attachment tool 100 (described later), and lower attachment tool 200 (described later) is referred to as an attachment apparatus for a vehicular door latch.

Window regulator WR is connected to window glass G so as to enable a vertical opening/closing operation of window glass G. Inside handle IH is connected to door latch 1 so as to be operated when door D is opened from the interior of the vehicle.

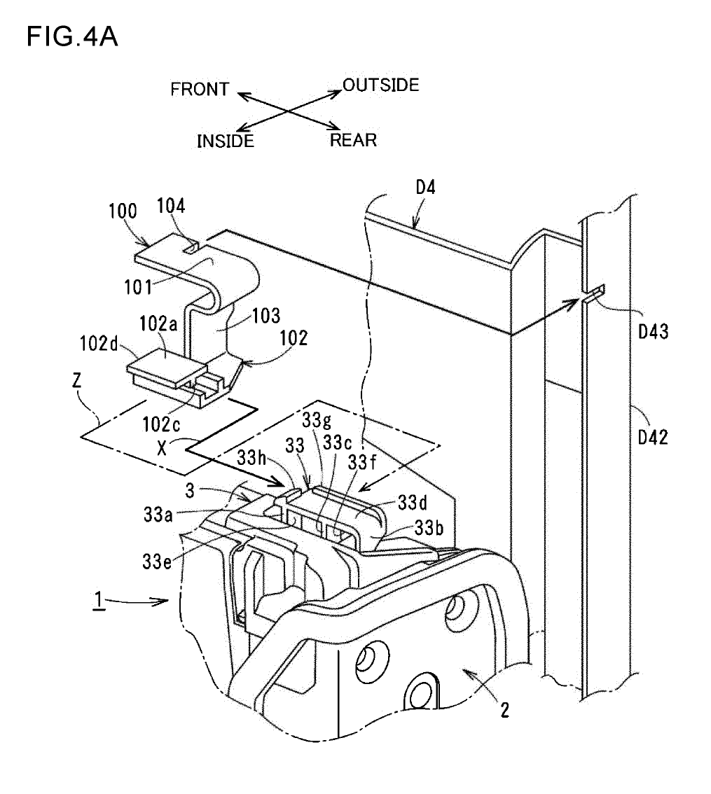

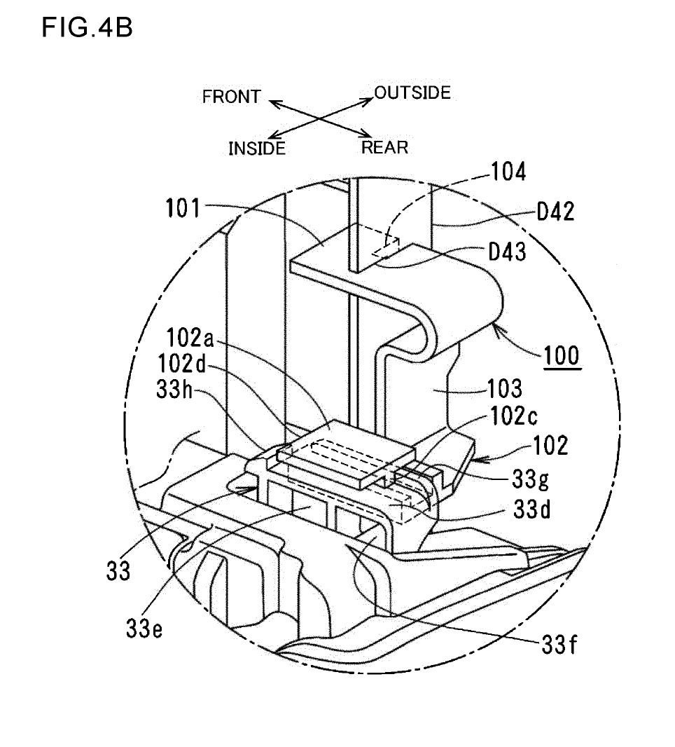

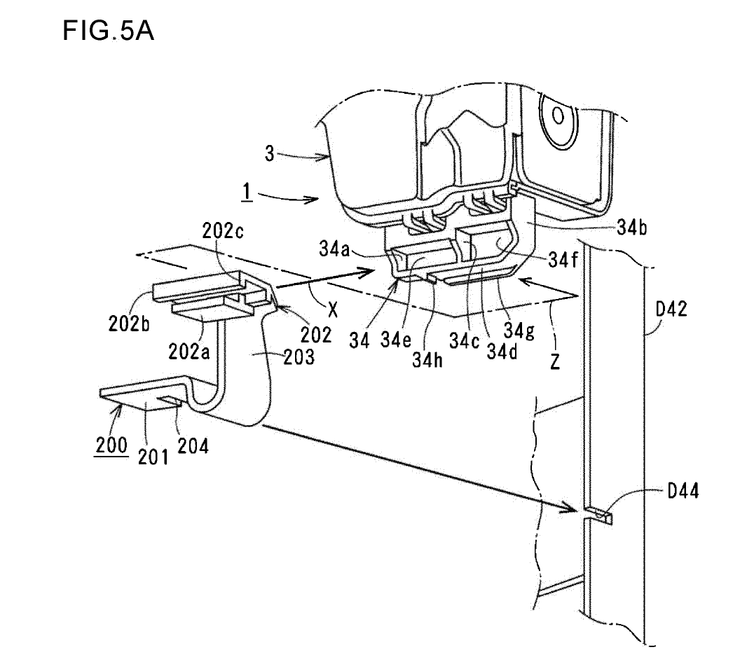

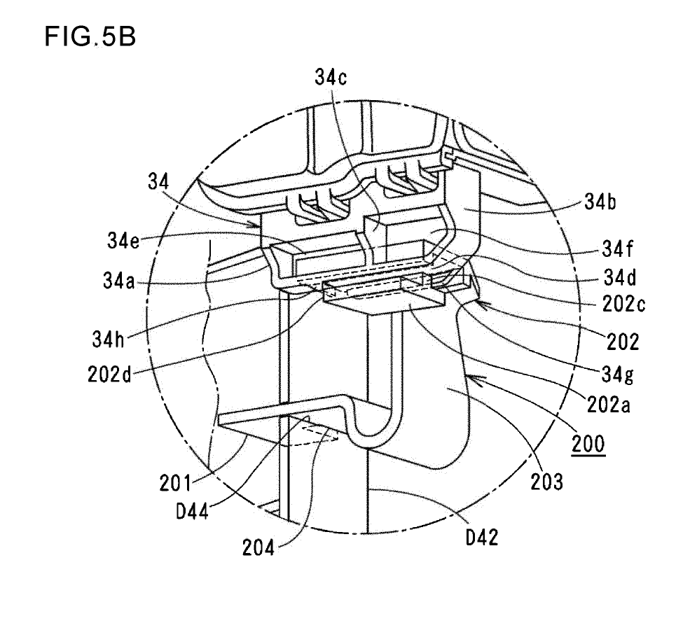

Module base D4 includes base part D41 on which inside handle IH and window regulator WR are disposed, and includes extension part D42 provided continuously from the rear portion of base part D41. Base part D41 has a function of closing opening D3 in inside door panel D1. Upper locking portion D43 and lower locking portion D44 (see FIGS. 4A, 4B, 5A, and 5B) for temporally fixing door latch 1 via upper attachment tool 100 and lower attachment tool 200 (described later), respectively, are formed in extension part D42. In the present embodiment, upper locking portion D43 and lower locking portion D44 are each formed of a slit which is cut in the horizontal direction so as to be open toward the vehicle interior side.

As illustrated in FIG. 1A, door latch 1 is temporarily fixed to extension part D42 of module base D4 in advance via upper attachment tool 100 and lower attachment tool 200, which are formed separately from module base D4 and door latch 1. As illustrated in FIG. 1B, when module base D4 is fixed to inside door panel D2, door latch 1 temporarily fixed to extension part D42 is inserted, together with extension part D42, into door D through opening D3. In a subsequent process, door latch 1 is fixed to the rear inner surface of inside door panel D2 with the plurality of bolts B.

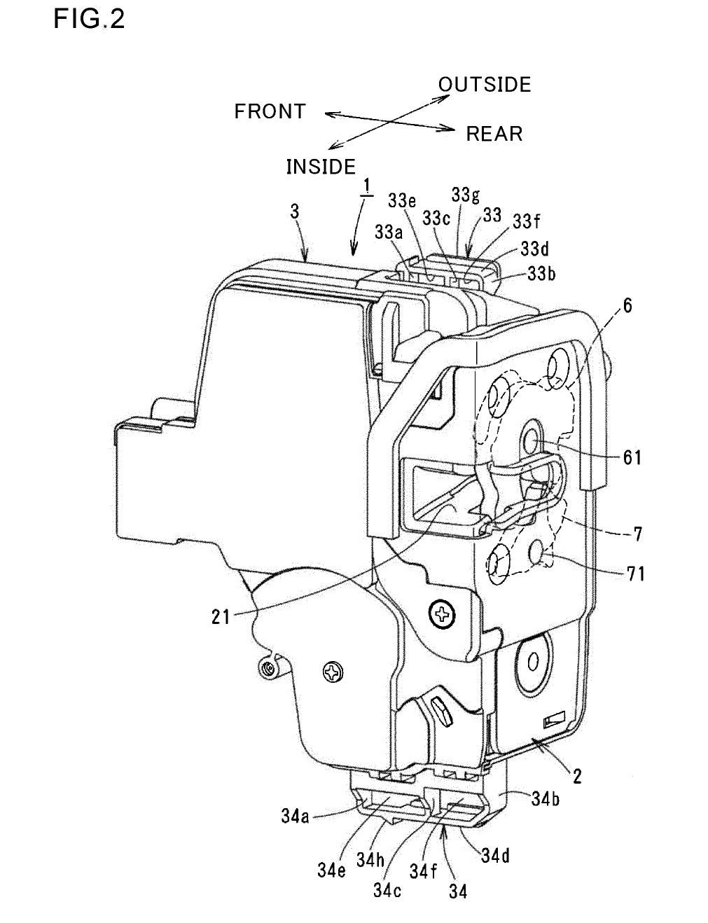

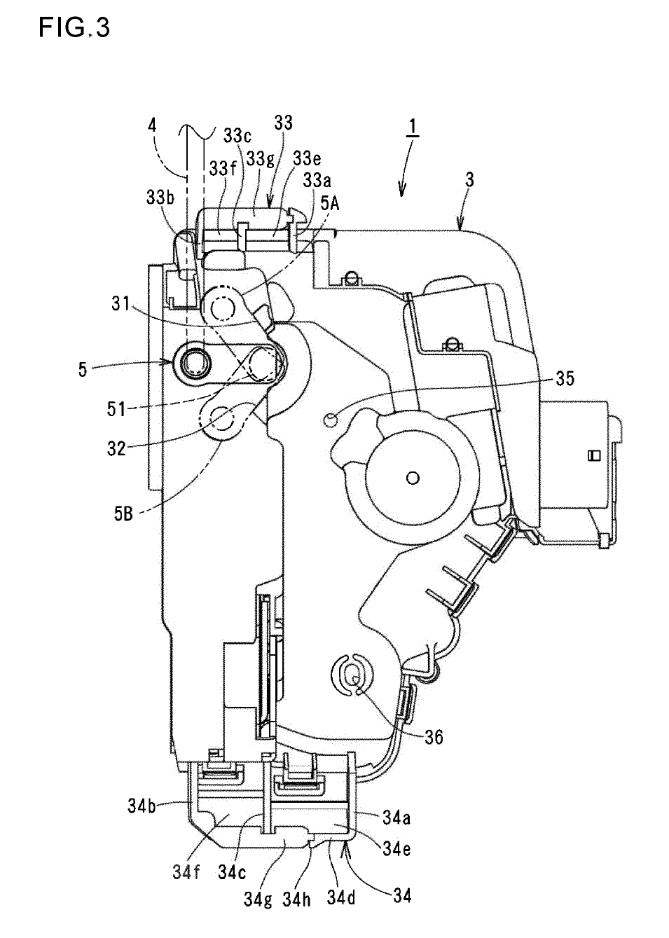

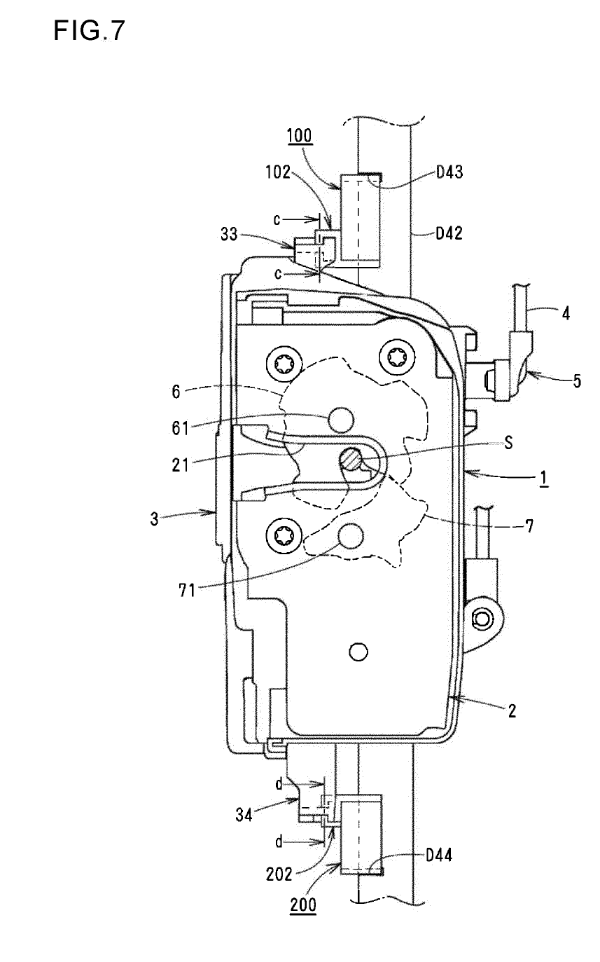

As illustrated in FIGS. 2 and 3, door latch 1 includes an engagement unit (reference number: none) having engagement mechanism housing 2 accommodating an engagement mechanism that holds a closed state of door D by being engaged with striker S (see FIG. 7) on the vehicle body side, and an operation unit (reference number: none) having operation mechanism housing 3 accommodating a door locking/unlocking mechanism (not illustrated) and other movable elements.

Engagement mechanism housing 2 of the engagement unit is fixed to the rear inner surface of inside door panel D2 with the plurality of bolts B. The engagement mechanism including latch 6 which is engageable with striker S and including ratchet 7 which engages with latch 6, restricts rotation of latch 6, and thereby holds door D in a closed state, is disposed in engagement mechanism housing 2.

Latch 6 is pivotally supported by shaft 61 inside engagement mechanism housing 2. Latch 6 engages striker S that enters striker entry groove 21 provided in engagement mechanism housing 2, when door D is closed.

Ratchet 7 is pivotally supported by shaft 71 inside engagement mechanism housing 2. Ratchet 7 restricts rotation of latch 6 by engaging latch 6 that has engaged striker S, and thereby holds door D in a closed state. Further, ratchet 7 operates in accordance with operation of the outside handle or inside handle IH so that ratchet 7 is released from engaging latch 6 and door D is allowed to open.

Operation mechanism housing 3 of the operation unit is fixed to engagement mechanism housing 2 so as to cover the entire rear side (the “front side” and the “vehicle exterior side” in a state where door latch 1 is attached to door D) of engagement mechanism housing 2. A door locking/unlocking mechanism (not illustrated) which is a movable element capable of performing switching, in accordance with a manual door locking/unlocking operation (operation of a key cylinder or a lock knob) or in accordance with an electrical opening/closing operation based on remote control through a mobile device (not illustrated), between a door unlocked state where door D is allowed to open by operation of the outside handle or inside handle IH and a door locked state where door D is not allowed to open, and other movable elements are provided in operation mechanism housing 3.

Among a plurality of components forming the door locking/unlocking mechanism, key lever 5 that is connected to the key cylinder via vertically extending connection member 4 is supported by operation mechanism housing 3 so as to be rotated at a prescribed angle. When door locking operation is performed on the key cylinder through a key, key lever 5 is rotated about axis section 51 counterclockwise from a neutral position indicated by a solid line in FIG. 3. As a result, the door locking/unlocking mechanism is switched to the door locked state. When a door unlocking operation is performed on the key cylinder through a key, key lever 5 is rotated about axis section 51 clockwise from the neutral position. As a result, the door locking/unlocking mechanism is switched to the door unlocked state.

In operation mechanism housing 3, upper stopper 31 and lower stopper 32 for limiting the rotation angle of key lever 5 to a predetermined angle, upper locking member 33 and lower locking member 34 to which upper attachment tool 100 and lower attachment tool 200 are respectively attached, and upper recessed section 35 and lower recessed section 36 which are used when door latch 1 is assembled, are integrally formed. In the present embodiment, locking member 33 and lower locking member 34 are a set of locking members.

When key lever 5 is rotated clockwise from the neutral position in accordance with a door unlocking operation performed on the key cylinder, the upper edge of key lever 5 comes into contact with upper stopper 31 as indicated by a two-dot chain line 5A in FIG. 3, whereby rotation of key lever 5 is stopped. When key lever 5 is rotated counterclockwise from the neutral position in accordance with a door locking operation performed on the key cylinder, the lower edge of key lever 5 comes into contact with lower stopper 32 as indicated by a two-dot chain line 5B in FIG. 3, whereby rotation of key lever 5 is stopped. In this way, even if a force that is sufficient to rotate key lever 5 at the prescribed angle or larger is applied when the key cylinder is operated, upper stopper 31 and lower stopper 32 can reliably stop key lever 5 at the predetermined angle. Accordingly, upper stopper 31 and lower stopper 32 prevent an excess load input from being applied onto the door locking/unlocking mechanism (excluding key lever 5), so that damage to the door locking/unlocking mechanism cab be prevented.

As illustrated in FIG. 3, upper recessed section 35 is formed at the rear surface side of operation mechanism housing 3 so as to have a circular shape. Lower recessed section 36 is formed at the rear surface side of operation mechanism housing 3 so as to have a long hole shape which is long in the vertical direction. When the movable elements including the door locking/unlocking mechanism are attached to operation mechanism housing 3 from above in the assembly line of door latch 1, upwardly-facing columnar fixed pins provided on an assembly jig are inserted in upper recessed section 35 and lower recessed section 36 such that the fixing position of operation mechanism housing 3 to the assembly jig is ensured for correct attachment of the movable elements.

As illustrated in FIGS. 4A, 4B, 8A, and 9A, upper locking member 33 includes front and rear rising sections 33a, 33b, center rising section 33c, connection piece 33d connecting the upper ends of the rising sections 33a, 33b, 33c, and front and rear fitting holes 33e, 33f open toward the vehicle interior-exterior direction (the transverse direction), which are formed in the upper portion of operation mechanism housing 3.

First protruding section 33g protruding upwardly and downwardly from the upper surface and the lower surface of connection piece 33d and extending in the front-rear direction is provided at an end, of connection piece 33d, directed to the outside of the vehicle. Second protruding section 33h protruding upwardly from the upper surface of connection piece 33d is provided at the front portion of connection piece 33d.

As illustrated in FIGS. 5A, 5B, 8B, and 9B, lower locking member 34 includes front and rear hanging sections 34a, 34b, center hanging section 34c, connection piece 34d connecting the lower ends of hanging sections 34a, 34b, 34c, and front and rear fitting holes 34e, 34f open toward the vehicle interior-exterior direction (the transverse direction), which are formed in the lower portion of operation mechanism housing 3.

First protruding section 34g protruding upwardly and downwardly from the upper surface and the lower surface of connection piece 34d and extending in the front-rear direction is provided at an end, of connection piece 34d, directed to the outside of the vehicle. Second protruding section 34h protruding downwardly from the lower surface of connection piece 34d is provided at the front portion of connection piece 34d.

As illustrated in FIGS. 4A and 4B, in upper attachment tool 100, module base side to-be-locked member 101 which is to be locked to extension part D42 of module base D4, door latch side to-be-locked member 102 which is disposed below module base side to-be-locked member 101 and which is to be locked to upper locking member 33 of door latch 1, and connection section 103 connecting module base side to-be-locked member 101 and door latch side to-be-locked member 102 with each other and extending in the vertical direction, are integrally formed.

Module base side to-be-locked member 101 of upper attachment tool 100 has cut-off section 104 which is vertically cut off so as to be open toward the outside of the vehicle (a side that faces upper locking portion D43). As illustrated in FIG. 4B, cut-off section 104 is engaged, at a right angle, with upper locking portion D43 of module base D4, and thereby, is locked to extension part D42 of module base 4.

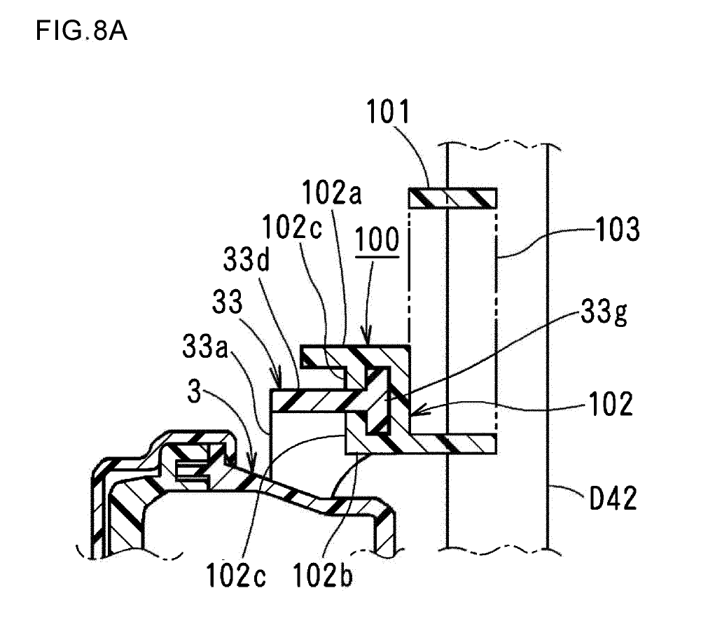

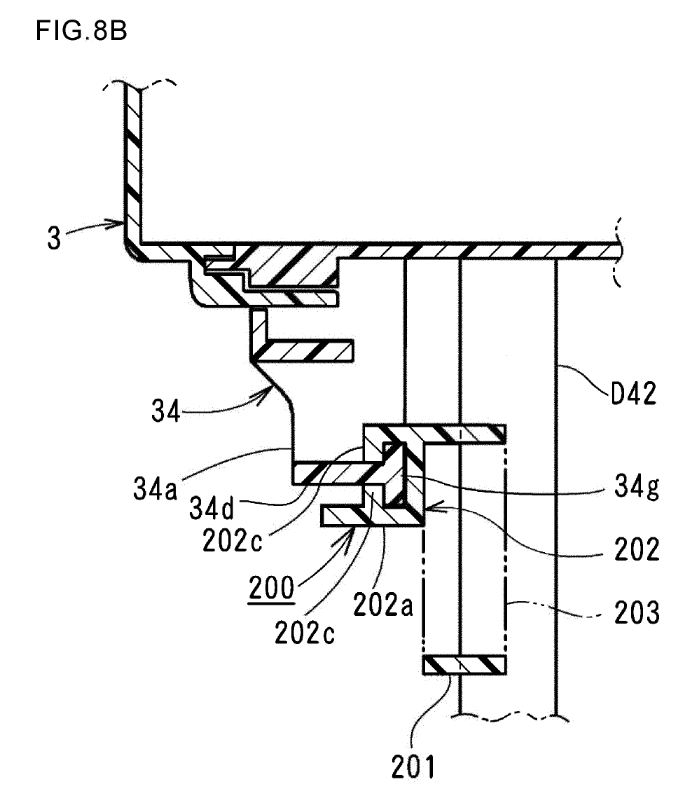

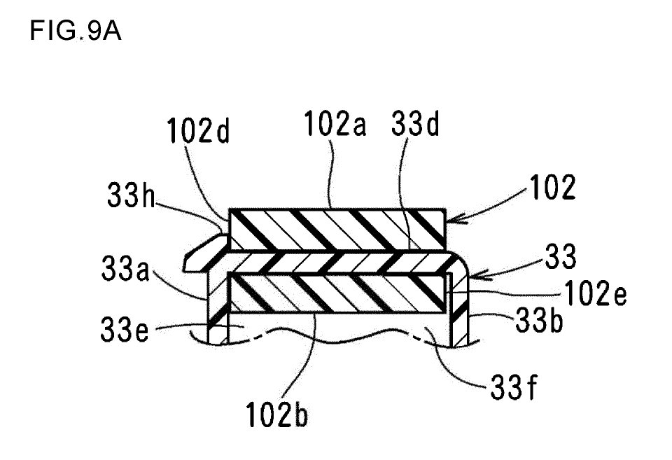

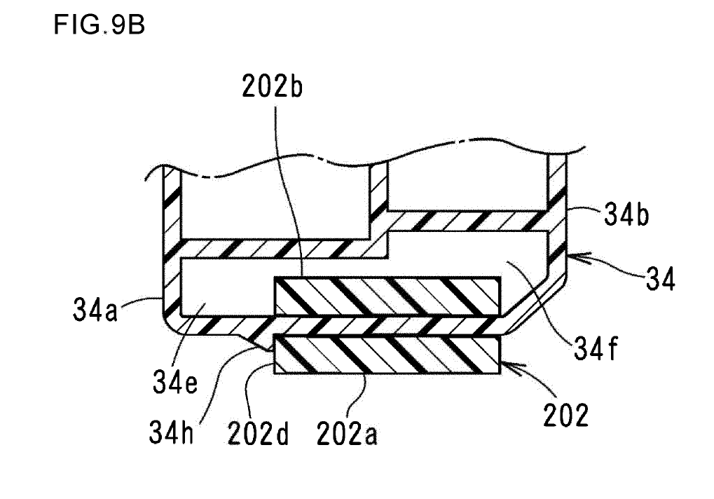

As illustrated in FIGS. 8A and 9A, door latch side to-be-locked member 102 of upper attachment tool 100 has upper pinching piece 102a which comes into contact with the upper surface of connection piece 33d of upper locking member 33 of door latch 1, and lower pinching piece 102b which comes into contact with the lower surface of connection piece 33d. Connection piece 33d of upper locking member 33 is pinched from above and below between upper pinching piece 102a and lower pinching piece 102b, so that door latch side to-be-locked member 102 is fixed by being fitted to upper locking member 33 of door latch 1.

As illustrated particularly in FIG. 8A, in upper attachment tool 100, upper and lower claw sections 102c which are engageable respectively with the upper and lower portions of first protruding section 33g of upper locking member 33 toward a coming-off direction (the right direction in FIG. 8A), are provided on mutually facing surfaces of upper pinching piece 102a and lower pinching piece 102b.

As illustrated in FIG. 8A, in a state where upper attachment tool 100 is fixed by being fitted to upper locking member 33 of door latch 1 (in a state where connection piece 33d of upper locking member 33 is pinched between upper pinching piece 102a and lower pinching piece 102b), upper and lower claw sections 102c are engaged respectively with the upper and lower portions of first protruding section 33g. As illustrated in FIG. 9A, end 102d of upper pinching piece 102a is engages second protruding section 33h in a direction towards the front, and end 102e of lower pinching piece 102b comes into contact with the inner side surface of rising section 33b of upper locking member 33. Accordingly, upper attachment tool 100 is prevented from coming off door latch 1 during transportation of door latch 1 or during attachment to door D.

Module base side to-be-locked member 101 of upper attachment tool 100 is locked to extension part D42 of module base D4 and door latch side to-be-locked member 102 is fixed by being fitted to upper locking member 33 of door latch 1, as described above, whereby the upper portion of door latch 1 can be temporarily fixed to extension part D42 of module base 4 via upper attachment tool 100.

As illustrated in FIGS. 5A and 5B, lower attachment tool 200 has a shape vertically symmetrical to the shape of upper attachment tool 100. In lower attachment tool 200, module base side to-be-locked member 201 which is to be locked to extension part D42 of module base D4, door latch side to-be-locked member 202 which is disposed above module base side to-be-locked member 201 and which is to be fixed by being fitted to lower locking member 34 of door latch 1, and connection section 203 connecting module base side to-be-locked member 201 and door latch side to-be-locked member 202 with each other and extending in the vertical direction, are integrally formed.

Further, as illustrated in FIGS. 5A and 5B, module base side to-be-locked member 201 of lower attachment tool 200 has cut-off section 204 which is cut off in the vertical direction so as to be open toward the outside of the vehicle (a side to face lower locking portion D44). As illustrated in FIG. 5B, in module base side to-be-locked member 201 cut-off section 204 is engaged, at a right angle, with lower locking portion D44 of module base D4, and thereby, is locked by extension part D42 of module base 4.

As illustrated in FIGS. 8B and 9B, door latch side to-be-locked member 202 of lower attachment tool 200 has lower pinching piece 202a which comes into contact with the lower surface of connection piece 34d of lower locking member 34 of door latch 1, and upper pinching piece 202b which comes into contact with the upper surface of connection piece 34d. Connection piece 34d of lower locking member 34 is pinched from above and below between lower pinching piece 202a and upper pinching piece 202b, so that door latch side to-be-locked member 202 is fixed by being fitted to lower locking member 34 of door latch 1.

As illustrated particularly in FIG. 8B, in lower attachment tool 200, upper and lower claw sections 202c which are engageable respectively with the upper and lower portions of protruding section 34g of lower locking member 34 toward a coming-off direction (the right direction in FIG. 8B) are provided on mutually facing surfaces of lower pinching piece 202a and upper pinching piece 202b.

As illustrated in FIG. 8B, in a state where lower attachment tool 200 is fixed by being fitted to lower locking member 34 of door latch 1 (in a state where connection piece 34d of lower locking member 33 is pinched between upper pinching piece 202b and lower pinching piece 202a), upper and lower claw sections 202c respectively engage the upper and lower portions of first protruding section 34g. As illustrated in FIG. 9B, end 202d of lower pinching piece 202a engages second protruding section 34h in a direction towards the front. Accordingly, lower attachment tool 200 is prevented from coming off door latch 1 during transportation of door latch 1 or during attachment to door D.

Module base side to-be-locked member 201 of lower attachment tool 200 is locked to extension part D42 of module base D4, and door latch side to-be-locked member 202 of lower attachment tool 200 is fixed by being fitted to lower locking member 34 of door latch 1, as described above, whereby the lower portion of door latch 1 can be temporarily fixed to extension part D42 of module base 4 via lower attachment tool 200. In the present embodiment, upper attachment tool 100 and lower attachment tool 200 are a set of attachment tools.

Next, the main points as regards attaching the door module are described.

First, upper attachment tool 100 and lower attachment tool 200 are attached to upper locking member 33 and lower locking member 34 of door latch 1, respectively. In upper attachment tool 100, while upper pinching piece 102a is upwardly warped, connection piece 33d of upper locking member 33 is inserted, in an X arrow direction shown in FIG. 4A, so as to be pinched between upper pinching piece 102a and lower pinching piece 102b, whereby the above attachment is achieved. As a result, claw sections 102c of upper attachment tool 100 engage first protruding section 33g of upper locking member 33 and end 102d of upper pinching piece 102a engages second protruding section 33h of upper locking member 33, so that upper attachment tool 100 is correctly fixed by being fitted to upper locking member 33. In lower attachment tool 200, while lower pinching piece 202a is downwardly warped, connection piece 34d of lower locking member 34 is inserted, in an arrow X direction—shown in FIG. 5A, so as to be pinched between lower pinching piece 202a and upper pinching piece 202b, whereby the above attachment is achieved. As a result, claw sections 202c of lower attachment tool 200 engage first protruding section 34g of lower locking member 34 and end 202d of lower pinching piece 202a engages second protruding section 34h of lower locking member 34, so that lower attachment tool 200 is correctly fixed by being fitted to lower locking member 34.

Next, upper attachment tool 100 and lower attachment tool 200 locked to door latch 1, are locked to extension part D42 of locked module base D4, respectively. In upper attachment tool 100, cut-off section 104 in module base side to-be-locked member 101 engages upper locking portion D43 of extension part D42 of module base D4, whereby the above locking is achieved. In lower attachment tool 200, cut-off section 204 in module base side to-be-locked member 201 engages lower locking portion D44 of extension part D42, whereby the locking is achieved. As a result, door latch 1 can be temporarily fixed to module base D4 with ease via upper attachment tools 100 and lower attachment tool 200.

Next, extension part D42 of module base D4 having door latch 1, inside handle IH, and window regulator WR attached thereto is inserted into door D through opening D3 in inside door panel D2, and base part D41 is fixed to inside door panel D2. As a result, door latch 1 is placed at a predetermined attachment position in door D.

Finally, door latch 1 is fixed to the rear inner surface of inside door panel D2 with bolts B from the outside of door D, whereby attaching the door function components to door D is completed.

As a result of attaching of door latch 1 to module base D4 by using upper attachment tool 100 and lower attachment tool 200, as described above, the following effects are realized.

(a) No large attachment portion to be directly attached to module base D4 needs to be formed on door latch 1. Therefore, according to the present embodiment, door latch 1 can be downsized.
(b) In operation mechanism housing 3 of door latch 1, upper locking member 33 for temporarily fixing upper attachment tool 100 is integrally formed, and lower locking member 34 for temporarily fixing lower attachment tool 200 is integrally formed. Accordingly, door latch 1 can be attached to a plurality of types of module bases D4 having different shapes, only by exchanging upper attachment tool 100 and lower attachment tool 200, so that door latch 1 can be commonly used.
(c) Only by attaching upper attachment tool 100 and lower attachment tool 200 to module base D4, can door latch 1 be easily attached to module base D4.

One embodiment of the present disclosure has been described above. However, various modifications and changes of the present embodiment can be made within the gist of the present disclosure, and examples thereof are as follows.

(i) The shapes of module side to-be-locked members 101, 201 of upper attachment tool 100 and lower attachment tool 200 may be changed. For example, module side to-be-locked members 101, 201 are each formed into a projection shape projected toward the outside of the vehicle, and respective ends of the projection shapes are inserted into holes additionally provided in extension part D42 of module base D4, whereby module side to-be-locked members 101, 201 are locked.
(ii) The shapes of door latch side to-be-locked member 102, 202 of upper attachment tool 100 and lower attachment tool 200 and the shapes of locking members 33, 34 of door latch 1 may be changed. For example, either one of door latch side to-be-locked members 102 of upper attachment tool 100 and door latch side to-be-locked members 202 of lower attachment tool 200, or one of locking members 33, 34 of door latch 1 is formed into a projected shape projected toward the other to-be-locked member or the other locking member, and the other to-be-locked member or the other locking member is formed into a hole with which an end of the projected shape is engaged.
(iii) The attachment direction of upper attachment tool 100 (lower attachment tool 200) to door latch 1 may be changed. For example, in upper attachment tool 100 (lower attachment tool 200), lower pinching piece 102b (upper pinching piece 202b) is fitted, from the outside of the vehicle in an arrow Z direction shown in FIG. 4A (FIG. 5A), into fitting holes 33e, 33f (fitting holes 34e, 34f) in upper locking member 33 (lower locking member 34). Also, connection piece 33d (connection piece 34d) of upper locking member 33 (lower locking member 34) is pinched between upper pinching piece 102a (lower pinching piece 202a) and lower pinching piece 102b (upper pinching piece 202b).
(iv) Any one of (i) to (iii) can be combined with the other.

What is claimed is:

1. A vehicular door latch device comprising
a housing that accommodates a movable element, wherein
in the housing, at least one locking member to which at least one attachment tool that is locked to a module base is fixed by being fitted, is integrally formed.

2. The vehicular door latch device according to claim 1, wherein
the at least one attachment tool includes
a module base side to-be-locked member that is locked to the module base, and
a door latch side to-be-locked member that is fixed by being fitted to the locking member.

3. The vehicular door latch device according to claim 1, wherein
the at least one locking member comprises a set of locking members, and each of the set of locking members is provided at both of an upper portion and a lower portion of the housing.

4. The vehicular door latch device according to claim 2, wherein
the at least one locking member comprises a set of locking members, and each of the set of one locking members is provided at both of an upper portion and a lower portion of the housing.

5. The vehicular door latch device according to claim 3, wherein
the at least one attachment tool comprises a set of attachment tools, and each of the set of attachment tools is provided at both of an upper portion and a lower portion of the module base.

6. The vehicular door latch device according to claim 4, wherein
the at least one attachment tool comprises a set of attachment tools, and each of the set of attachment tools is provided at both of an upper portion and a lower portion of the module base.

7. The vehicular door latch device according to claim 5, wherein
the shape of each of the set of attachment tools is vertically symmetrical.

8. The vehicular door latch device according to claim 6 wherein
the shape of each of the set of attachment tools is vertically symmetrical.

9. An attachment apparatus for a vehicular door latch, the attachment apparatus comprising:
an attachment tool that is locked to a module base which is fixed to an inside door panel of a door; and
the vehicular door latch device according to claim 1, the vehicular door latch device being configured to be locked to the module base via the attachment tool by the attachment tool being fixed by being fitted to the at least one locking member.
